(19) United States
(12) Patent Application Publication
(10) Pub. No.: US 2025/0357747 A1
(43) Pub. Date: Nov. 20, 2025

(54) TRANSIENT DIVERTING SUPPRESSOR WITH LOW DV/DT CURRENT

(71) Applicant: Semtech Corporation, Camarillo, CA (US)

(72) Inventors: Lei Hua, Camarillo, CA (US); Pengcheng Han, Calabasas, CA (US); Changjun Huang, Oak Park, CA (US)

(73) Assignee: Semtech Corporation, Camarillo, CA (US)

(21) Appl. No.: 18/816,015

(22) Filed: Aug. 27, 2024

Related U.S. Application Data
(60) Provisional application No. 63/648,984, filed on May 17, 2024.

(51) Int. Cl. H02H 3/44; H02H 9/04

(52) U.S. Cl. CPC H02H 3/44; H02H 9/04

(57) ABSTRACT

A voltage protection circuit, comprising a dV/dt triggered turn-on circuit configured to receive an input voltage and to turn on a switch when a change in voltage over time exceeds a predetermined level. A voltage limiting circuit coupled to the dv/dt triggered turn-on circuit and configured to limit a maximum voltage seen by the dV/dt triggered turn-on circuit. A current sharing circuit coupled to the dV/dt triggered turn-on circuit and configured to control a level of current through the dV/dt triggered turn-on circuit. A level shifting circuit coupled to the dV/dt triggered turn-on circuit and configured to shift a DC voltage level of the dV/dt triggered turn-on circuit.

### RELATED APPLICATIONS

The present application claims benefit of and priority to U.S. Provisional patent application 63/648,984, filed May 17, 2024, which is hereby incorporated by reference for all purposes as if set forth herein in its entirety.

### TECHNICAL FIELD

The present disclosure relates generally to electrical circuits, and more specifically to a transient diverting suppressor with a low dV/dt current.

### BACKGROUND OF THE INVENTION

Transient suppression is used to prevent damage to electrical components.

### SUMMARY OF THE INVENTION

A voltage protection circuit is disclosed that includes a dV/dt triggered turn-on circuit that receives an input voltage and turns on a switch when a change in voltage over time exceeds a predetermined level. A voltage limiting circuit coupled to the dv/dt triggered turn-on circuit limits a maximum voltage seen by the dV/dt triggered turn-on circuit. A current sharing circuit coupled to the dV/dt triggered turn-on circuit controls a level of current through the dV/dt triggered turn-on circuit. A level shifting circuit coupled to the dV/dt triggered turn-on circuit shifts a DC voltage level of the dV/dt triggered turn-on circuit.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a circuit with a transient voltage suppressor (TVS), in accordance with and example embodiment of the present disclosure;

FIG. 2 is a diagram of the current-voltage characteristics of the disclosed inventive TVS circuits with no snap-back, in accordance with and example embodiment of the present disclosure;

FIG. 3 is a diagram of the current-voltage characteristics of the disclosed inventive TVS circuits with snap-back, in accordance with and example embodiment of the present disclosure;

FIG. 4 is a diagram of a circuit for a transient diverting suppressor (TDS) protection device, in accordance with an example embodiment of the present disclosure;

FIG. 5 is a diagram of a circuit for a TDS protection device, in accordance with and example embodiment of the present disclosure;

FIG. 6 is a diagram of a circuit for a shunt FET M1 with parasitic capacitances, in accordance with and example embodiment of the present disclosure;

FIG. 7 is a diagram of a circuit for a TDS with low dV/dt current, in accordance with and example embodiment of the present disclosure;

FIG. 8 is a diagram of a circuit for providing an alternative topology for the TDS with low dV/dt current using duality, in accordance with and example embodiment of the present disclosure;

FIG. 9 is a diagram of a circuit for a simplified low dV/dt current topology, in accordance with an example embodiment of the present disclosure;

FIG. 10 is a diagram of a circuit for providing a simplified low dV/dt current TDS topology, in accordance with an example embodiment of the present disclosure;

FIG. 11 is a diagram of a circuit for a simplified low dV/dt current TDS topology, in accordance with an example embodiment of the present disclosure;

FIG. 12 is a diagram of a circuit showing a simplified low dV/dt current TDS topology, in accordance with an example embodiment of the present disclosure;

FIG. 13 is a diagram of a circuit having a simplified low dV/dt current TDS topology, in accordance with an example embodiment of the present disclosure; and

FIG. 14 is a diagram of a circuit for a simplified low dV/dt current TDS topology, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

The present application claims benefit of and priority to U.S. Provisional patent application 63/648,984, filed May 17, 2024, which is hereby incorporated by reference for all purposes as if set forth herein in its entirety.

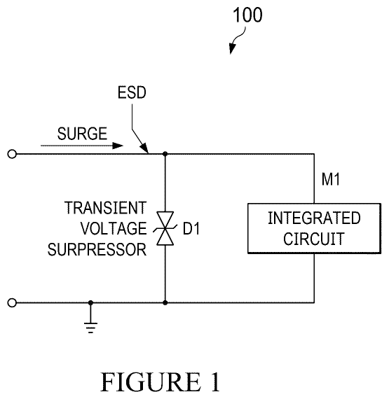

FIG. 1 is a diagram of a circuit 100 with a transient voltage suppressor (TVS) to protect integrated circuit M1 from electrical overstress (EOS) events such as electrostatic discharge (ESD) and surge overvoltages associated with lightning surge, in accordance with and example embodiment of the present disclosure. The TVS D1 is shown as a Zener diode but that is symbolically used to represent the disclosed inventive TVS circuits that are used to protect integrated circuit M1 from damages caused by either surge or by ESD events.

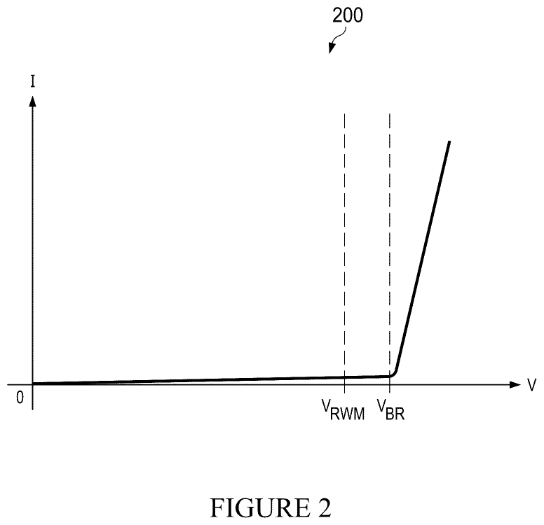

FIG. 2 is a diagram 200 of the current-voltage characteristics of the disclosed inventive TVS circuits with no snap-back, in accordance with and example embodiment of the present disclosure.

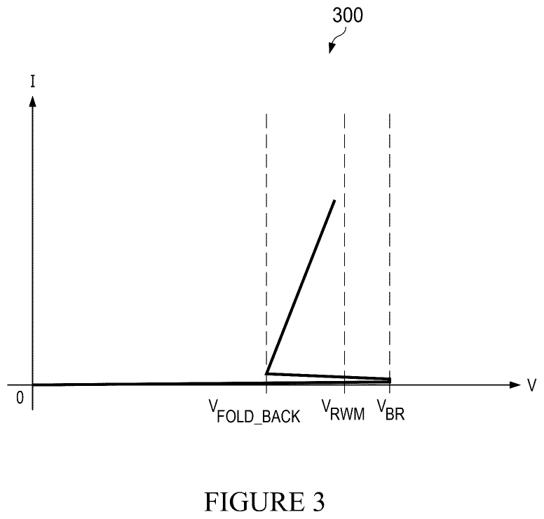

FIG. 3 is a diagram 300 of the current-voltage characteristics of the disclosed inventive TVS circuits with snap-back, in accordance with and example embodiment of the present disclosure.

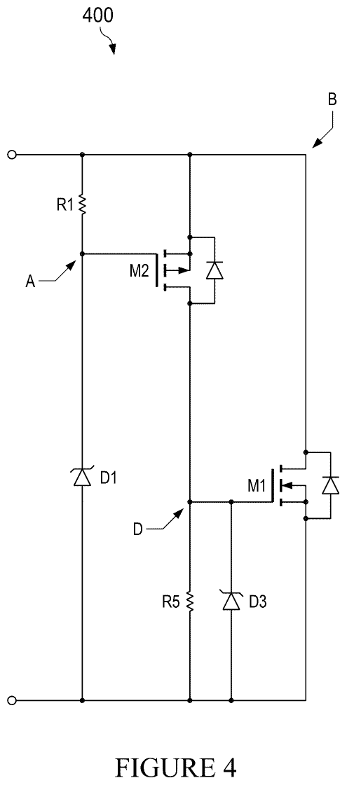

FIG. 4 is a diagram of a circuit 400 for a transient diverting suppressor (TDS) protection device, in accordance with an example embodiment of the present disclosure. Circuit 400 can be implemented in silicon, gallium arsenide, silicon carbide, gallium nitride, using metal-oxide semiconductors, bipolar junction devices or in other suitable manners.

Circuit 400 is configured to provide protection with a suitable current-voltage characteristic, such as that shown in diagram 200. M1 is n-channel power MOSFET (nFET) and M2 is a p-channel small signal MOSFET (pFET) that drives M1 when the voltage drop on resistor R1 exceeds the turn-on threshold of pFET M2. D1 is a Zener diode with a predetermined rated voltage that determines the maximum allowed working voltage on the protection device. Resistor R5 is the gate resistance on nFET M1. D3 is a Zener diode that serves the purpose of protecting the gate voltage of nFET M1. All devices are provided as examples and other suitable devices can also or alternatively be used.

When the voltage on Zener diode D1 is below the rated voltage, circuit 400 is in the off state. The gate of nFET M1 is grounded. When the input voltage to circuit 400 exceeds the rated voltage of Zener diode D1 to a certain level, the voltage drop across resistor R1 is high enough so that pFET M2 turns on. When pFET M2 turns on, the gate of nFET M1 is pulled up high and nFET M1 is fully turned on, shunting the input current to ground to protect circuit 400.

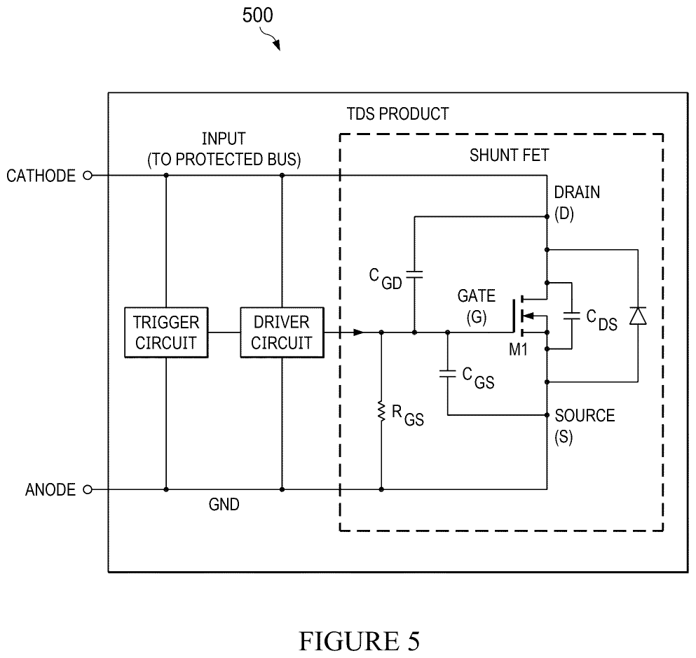

FIG. 5 is a diagram of a circuit 500 for a TDS protection device, in accordance with and example embodiment of the present disclosure. Circuit 500 can be implemented in silicon, gallium arsenide, silicon carbide, gallium nitride, using metal-oxide semiconductors, bipolar junction devices or in other suitable manners. All devices are provided as examples and other suitable devices can also or alternatively be used.

In circuit 500, nFET M1 serves as the main shunt device, bypassing the surge current to ground whenever there is an EOS event. To allow more current to bypass circuit 500 through nFET M1 during such events, the current rating of nFET M1 can be large. This large current rating can cause parasitic parameters such as the parasitic capacitance between the gate and the drain of nFET M1 to start to play a significant role in affecting the dynamic performance of nFET M1.

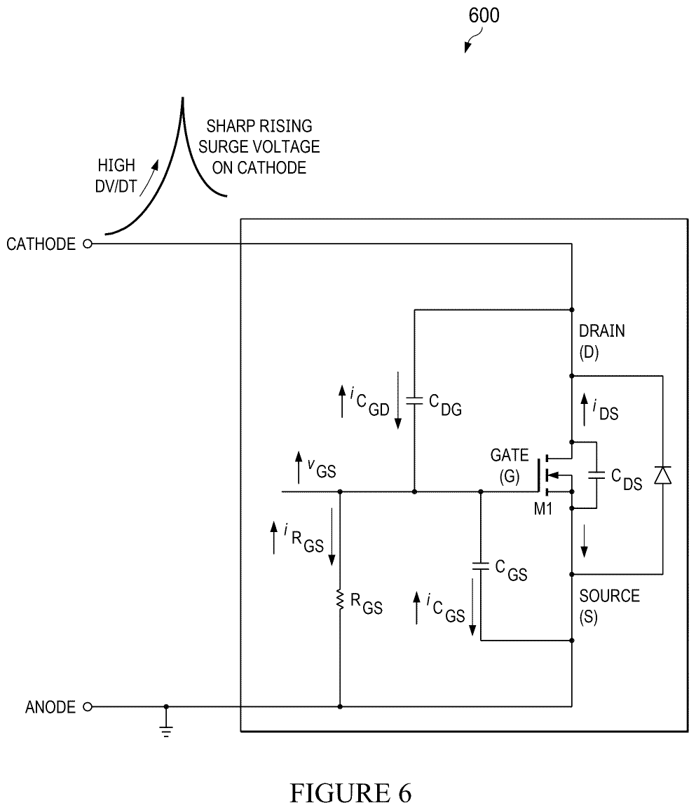

FIG. 6 is a diagram of a circuit 600 for a shunt FET M1 with parasitic capacitances, in accordance with and example embodiment of the present disclosure. Circuit 600 can be implemented in silicon, gallium arsenide, silicon carbide, gallium nitride, using metal-oxide semiconductors, bipolar junction devices or in other suitable manners. All devices are provided as examples and other suitable devices can also or alternatively be used.

Parasitic capacitances C_{DG}, C_{GS} and C_{DS} are present between the gate, drain and source of nFET M1. When there is a fast-rising voltage on the cathode of the circuit 600, current i_{CGD} flows through the parasitic capacitance C_{DG}, charging up capacitance C_{GS}. When V_{GS} of nFET M1 exceeds its turn-on threshold, nFET M1 turns on, allowing potentially large currents to flow from the cathode to the anode. This phenomenon is referred to as a “dv/dt triggered turn-on.”

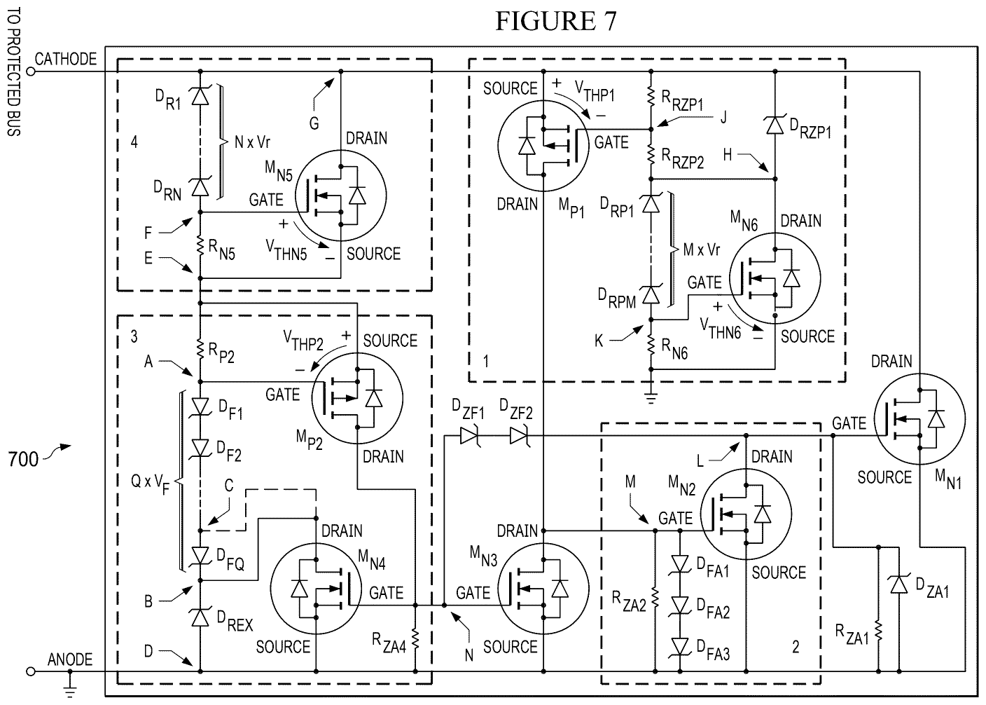

FIG. 7 is a diagram of a circuit 700 for a TDS with low dV/dt current, in accordance with and example embodiment of the present disclosure. Circuit 700 can be implemented in silicon, gallium arsenide, silicon carbide, gallium nitride, using metal-oxide semiconductors, bipolar junction devices or in other suitable manners. All devices are provided as examples and other suitable devices can also or alternatively be used.

Circuit 700 can be used to lower the dv/dt current of a TDS device when there is a fast-rising voltage spike. nFET M_{N1} is the main n-channel shunt FET and bypasses the EOS current from node G to node D. Resistance R_{ZA1} is the gate to source resistance for nFET M_{N1} and Zener diode D_{ZA1} is the used to limit the maximum voltage across from the gate to the source of nFET M_{N1}.

Circuit 700 includes 4 functional blocks. The circuitry in block 1 controls the on and off of nFET M_{N2} at the beginning of each EOS event. If resistance R_{RZP1} and resistance R_{RZP2} are large and the size of pFET M_{P1} is large, pFET M_{P1} can be triggered to start to pump current to resistance R_{ZA2}. nFET M_{N2} can then turn on, since resistance R_{ZA2} is large. Zener diodes D_{FA1} to D_{FA3} limit the maximum voltage imposed between the gate and source of nFET M_{N2}. nFET M_{N1} remains in off state while nFET M_{N2} is in on state, which limits the dv/dt current flowing through nFET M_{N1}.

Block 4 functions like serial Zener diodes, which can level-shift a certain amount of DC voltage from the potential on the cathode (node G) so that the potential of node E should be:

$${V}_{E} = {V}_{G} - ( N \cdot Vr + {V}_{THN 5} )$$

When the voltage across between the cathode and the anode is less than (N·Vr+V_{THN5}), the voltage from node E to node D will be zero, which will keep pFET M_{P2} in off state.

When the potential at node G exceeds the value of (N·Vr+V_{THN5})+(Q·V_{F}+V_{REX}+V_{THP2}), the pFET M_{P2} turns on and starts to pump current to resistance R_{ZA4}, which can have a large value. The potential at node N can rise fast and then exceed the turn-on thresholds of nFET M_{N3} and nFET M_{N4}. nFET M_{N2} would be turned off when nFET M_{N3} is turned on, releasing the gate of nFET M_{N1} from being grounded.

The drain of nFET M_{N4} can be tied to node B or to node C, depending on how much voltage needs to be subtracted when the clamping happens. In this example embodiment, the voltage between node E and node D can be kept at less than 4V to provide a current sharing function. The potential of node N is also clamped by the potential of node L with two forward diode drops higher like V_{DZF1}+V_{DZF2}. nFET M_{N4} is not required if the voltage from node A to node D is less than 4V at the beginning of an EOS event.

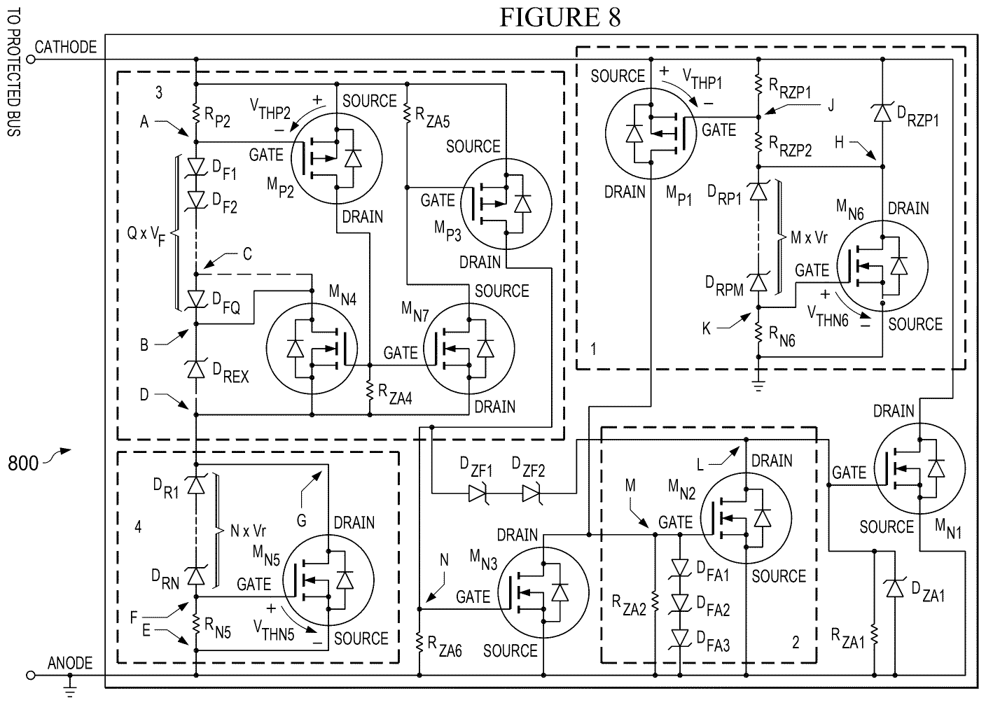

FIG. 8 is a diagram of a circuit 800 for providing an alternative topology for the TDS with low dV/dt current using duality, in accordance with and example embodiment of the present disclosure. Circuit 800 can be implemented in silicon, gallium arsenide, silicon carbide, gallium nitride, using metal-oxide semiconductors, bipolar junction devices or in other suitable manners. All devices are provided as examples and other suitable devices can also or alternatively be used.

Circuit 800 also includes four function blocks. Block 4 is now placed below block 3 at the bottom. The logic of the triggering mechanism remains the same as in circuit 700, where one difference is that pFET M_{P3} and nFET M_{N7} of circuit 800 are needed to level shift the driving signal, which was previously referred to node D of circuit 700. The driving signal of circuit 800 is referred to node E so that nFET M_{N1} can be driven.

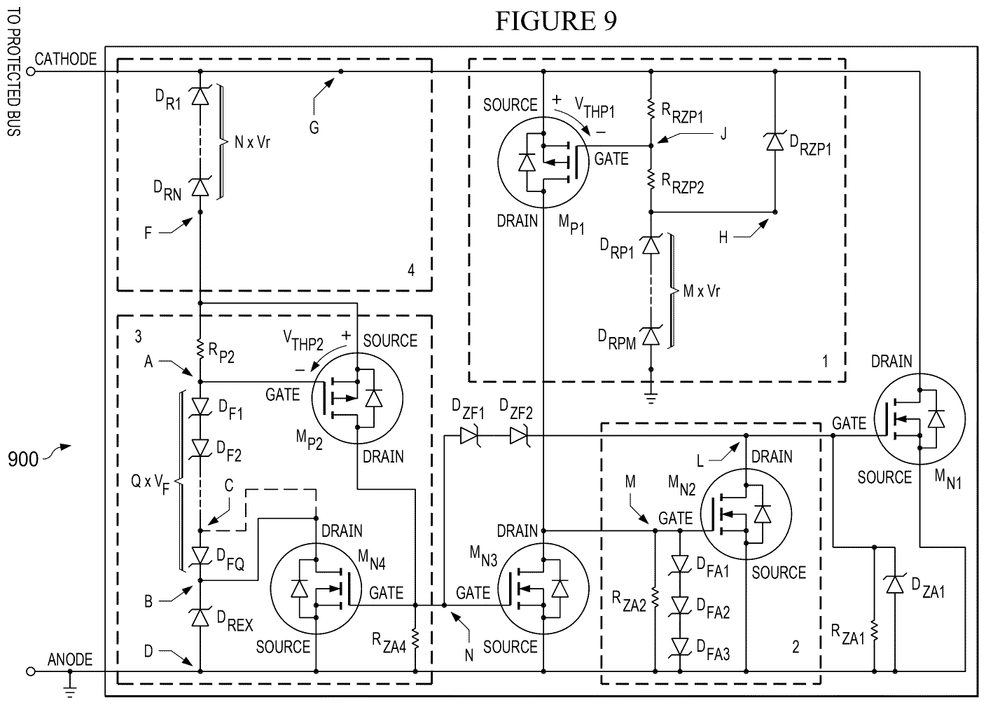

FIG. 9 is a diagram of a circuit 900 for a simplified low dV/dt current TDS topology, in accordance with an example embodiment of the present disclosure. Circuit 900 can be implemented in silicon, gallium arsenide, silicon carbide, gallium nitride, using metal-oxide semiconductors, bipolar junction devices or in other suitable manners. All devices are provided as examples and other suitable devices can also or alternatively be used. Circuit 900 is similar to circuit 700 without nFET M_{N5} and nFET M_{N6}, and also uses Zener strings in block 1 and block 4.

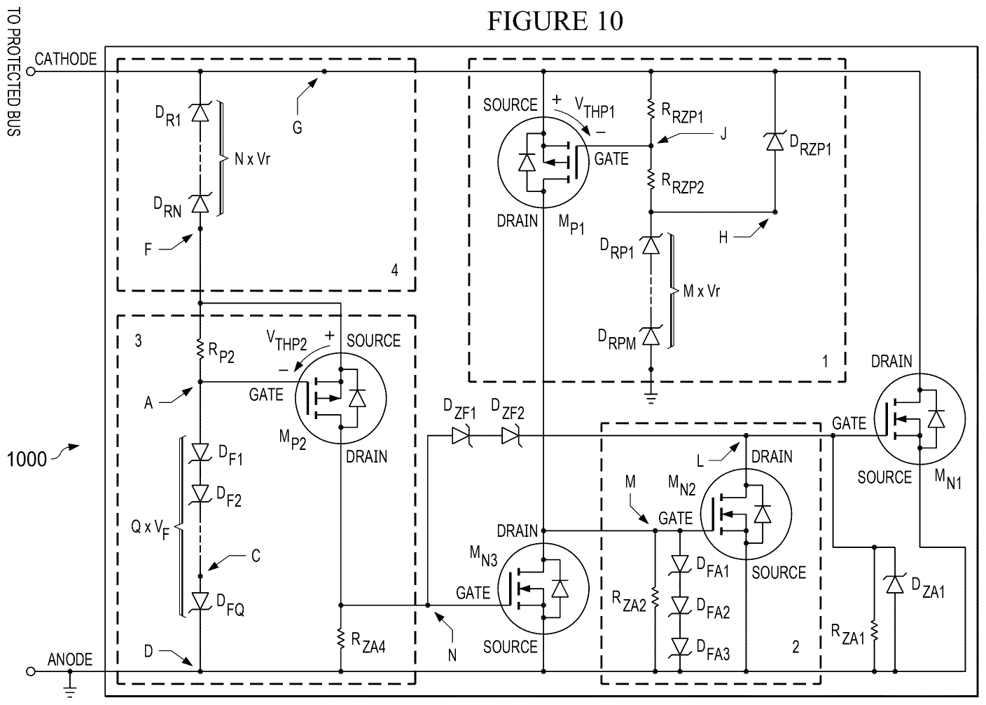

FIG. 10 is a diagram of a circuit 1000 for providing a simplified low dV/dt current TDS topology, in accordance with an example embodiment of the present disclosure. Circuit 1000 can be implemented in silicon, gallium arsenide, silicon carbide, gallium nitride, using metal-oxide semiconductors, bipolar junction devices or in other suitable manners. All devices are provided as examples and other suitable devices can also or alternatively be used. Circuit 1000 is similar to circuit 900, with M_{N4} from circuit 900 deleted to further simplify the circuit when the voltage from node A to node D is less than 4V.

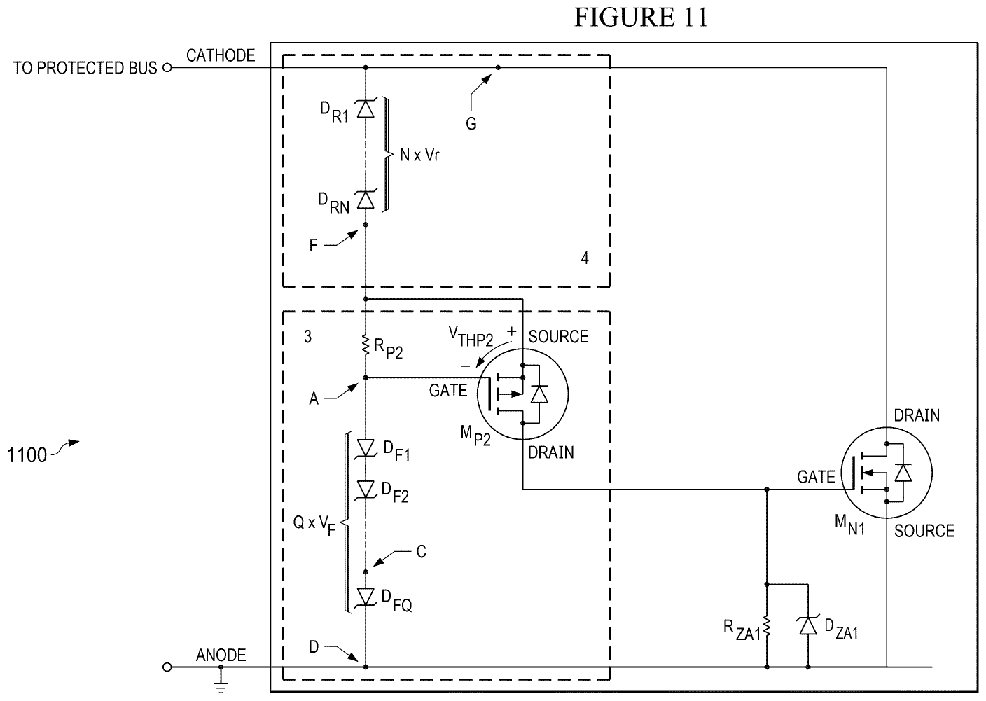

FIG. 11 is a diagram of a circuit 1100 for a simplified low dV/dt current TDS topology, in accordance with an example embodiment of the present disclosure. Circuit 1100 can be implemented in silicon, gallium arsenide, silicon carbide, gallium nitride, using metal-oxide semiconductors, bipolar junction devices or in other suitable manners. All devices are provided as examples and other suitable devices can also or alternatively be used. Circuit 1100 is similar to circuit 1000 without M_{N2} and M_{N3} and their peripheral circuits, which are deleted in order to simplify the circuit to reduce its die size.

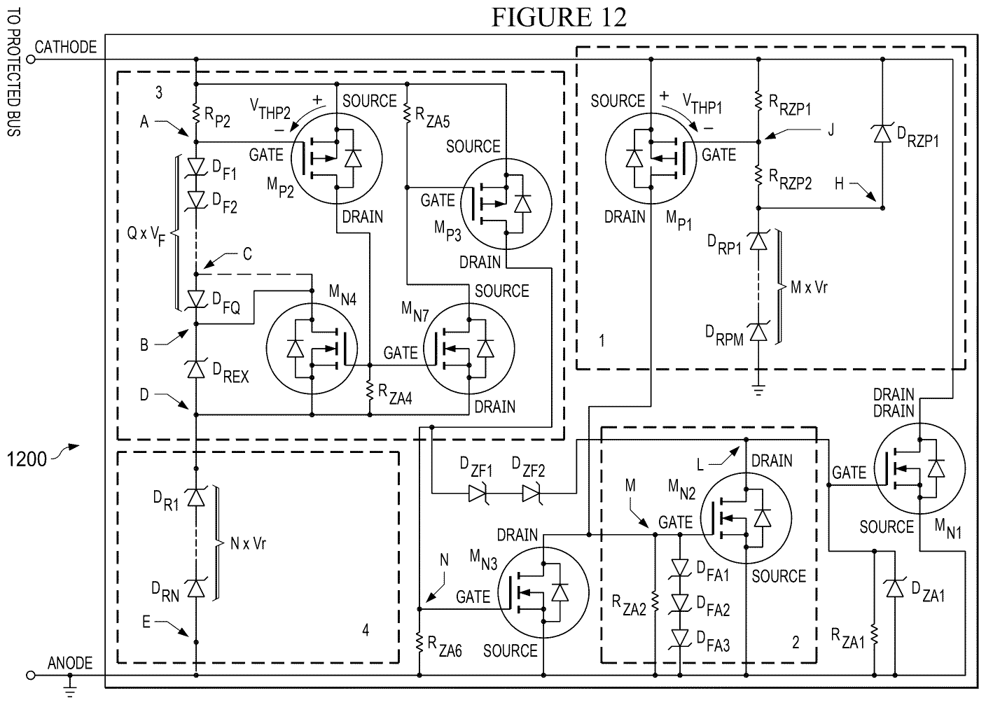

FIG. 12 is a diagram of a circuit 1200 showing a simplified low dV/dt current TDS topology, in accordance with an example embodiment of the present disclosure. Circuit 1200 can be implemented in silicon, gallium arsenide, silicon carbide, gallium nitride, using metal-oxide semiconductors, bipolar junction devices or in other suitable manners. All devices are provided as examples and other suitable devices can also or alternatively be used. Circuit 1200 is similar to circuit 800 without M_{N5} and M_{N6}, which are removed so that only the Zener strings are used in block #1 and in block #4.

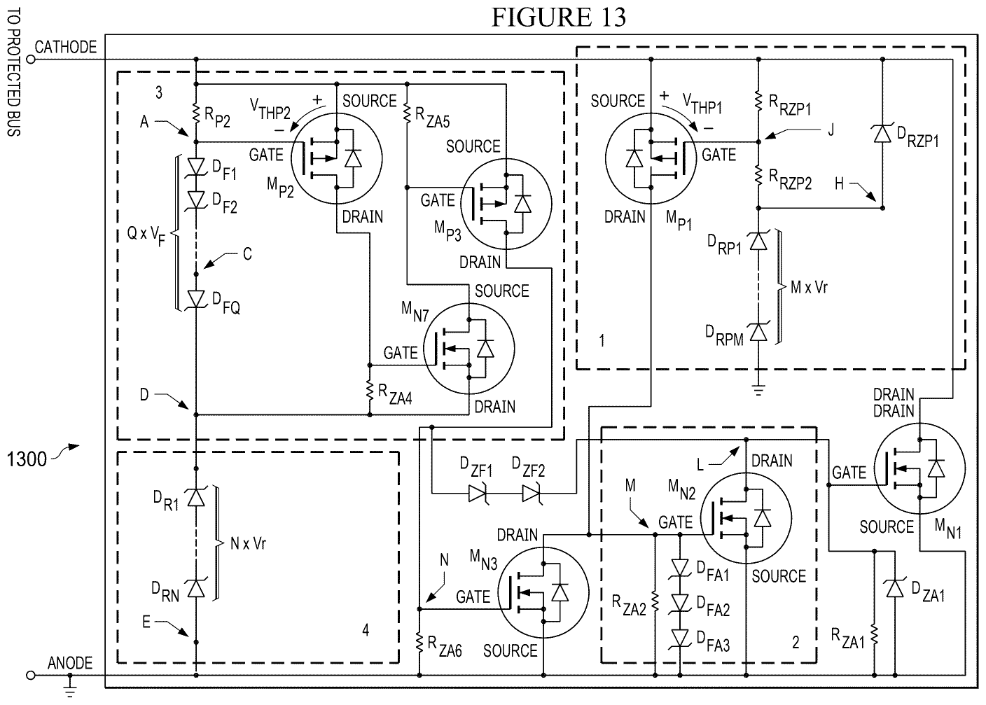

FIG. 13 is a diagram of a circuit 1300 having a simplified low dV/dt current TDS topology, in accordance with an example embodiment of the present disclosure. Circuit 1300 can be implemented in silicon, gallium arsenide, silicon carbide, gallium nitride, using metal-oxide semiconductors, bipolar junction devices or in other suitable manners. All devices are provided as examples and other suitable devices can also or alternatively be used. Circuit 1300 is similar to circuit 1200 without M_{N4}, which is removed to further simplify the circuit when the voltage from node A to node D is less than 4V.

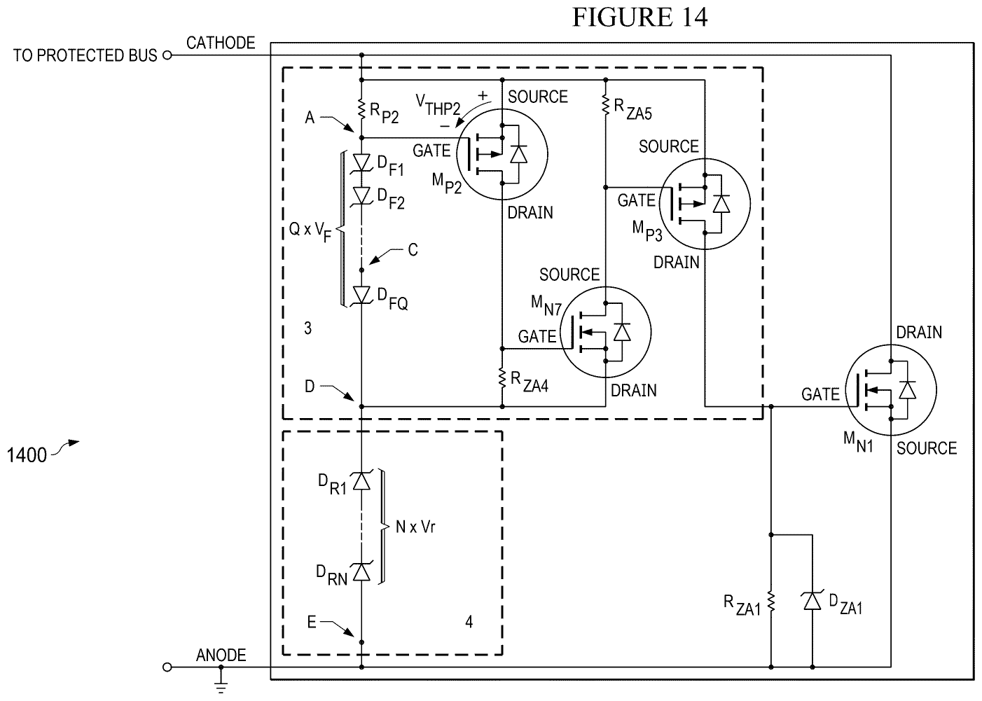

FIG. 14 is a diagram of a circuit 1400 for a simplified low dv/dt current TDS topology, in accordance with an example embodiment of the present disclosure. Circuit 1400 can be implemented in silicon, gallium arsenide, silicon carbide, gallium nitride, using metal-oxide semiconductors, bipolar junction devices or in other suitable manners. All devices are provided as examples and other suitable devices can also or alternatively be used. Circuit 1400 is similar to circuit 1300, with M_{N2} and M_{N3} plus their peripheral circuits deleted to further simplify the circuit to reduce its die size.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A voltage protection circuit, comprising:
dV/dt triggered turn-on circuit configured to receive an input voltage and to turn on a switch when a change in voltage over time exceeds a predetermined level;
a voltage limiting circuit coupled to the dv/dt triggered turn-on circuit and configured to limit a maximum voltage seen by the dV/dt triggered turn-on circuit;
a current sharing circuit coupled to the dV/dt triggered turn-on circuit and configured to control a level of current through the dV/dt triggered turn-on circuit; and
a level shifting circuit coupled to the dV/dt triggered turn-on circuit and configured to shift a DC voltage level of the dV/dt triggered turn-on circuit.

2. The voltage protection circuit of claim 1 wherein the dV/dt triggered turn-on circuit comprises an nFET transistor.

3. The voltage protection circuit of claim 1 wherein the dV/dt triggered turn-on circuit comprises an nFET transistor and a pFET transistor.

4. The voltage protection circuit of claim 1 wherein the dV/dt triggered turn-on circuit comprises:
an nFET transistor having a gate, a source and a drain; and
a pFET transistor having a gate and a drain coupled to the gate of the nFET transistor.

5. The voltage protection circuit of claim 1 wherein the voltage limiting circuit comprises an nFET transistor.

6. The voltage protection circuit of claim 1 wherein the voltage limiting circuit comprises a plurality of nFET transistors.

7. The voltage protection circuit of claim 1 wherein the voltage limiting circuit comprises a plurality of serial-connected Zener diodes.

8. The voltage protection circuit of claim 1 wherein the current sharing circuit comprises a pFET transistor.

9. The voltage protection circuit of claim 1 wherein the current sharing circuit comprises an nFET transistor.

10. The voltage protection circuit of claim 1 wherein the current sharing circuit comprises a pFET transistor having a gate coupled to a drain of an nFET transistor.

11. The voltage protection circuit of claim 1 wherein the level shifting circuit comprises an nFET transistor.

12. The voltage protection circuit of claim 1 wherein the level shifting circuit comprises a plurality of serially-connected Zener diodes.

13. The voltage protection circuit of claim 1 wherein the level shifting circuit comprises an nFET transistor coupled to a plurality of serially-connected Zener diodes.
